(19) United States
(12) Patent Application Publication
(10) Pub. No.: US 2009/0136900 A1
(43) Pub. Date: May 28, 2009

(54) Muffle for the production of dental prostheses

(76) Inventors: Harald Gritsch, Gries (AT); Max Worishofer, Telfs (AT); Christoph Zobler, Aldrans (AT)

Correspondence Address: John C. Thompson, 69 Grayton Road, Tonawanda, NY, 14150, US

(21) Appl. No.: 12/291,000

(22) Filed: Nov. 5, 2008

(30) Foreign Application Priority Data
Nov. 5, 2007 (AT) A 1773/2007

(51) Int. Cl. A61C 9/00; A61C 13/20

(52) U.S. Cl. 433/201.1; 433/215

(57) ABSTRACT

Muffle (1) for the production of dental prostheses (2), said muffle (1) being a body that is substantially rotationally symmetrical about the muffle axis (A), characterized in that the proportion of cylindrical surface regions (31) about the muffle axis (A)—relative to the total surface area of the outer contour (3) of the muffle (1)—is less than 30%, preferably less than 20%.

### CROSS-REFERENCE TO RELATED APPLICATIONS

This application claims foreign priority benefits under 35 U.S.C. §119(a)-(d) from Austrian patent application ser. no. A 1773/2007 filed Nov. 5, 2007.

### TECHNICAL FIELD

The invention relates to a muffle for the production of dental prostheses, the muffle being a substantially rotationally symmetrical body about the muffle axis. Moreover, the invention relates to a device and a method of production of a muffle. The invention further relates to a plunger for the production of dental prostheses in muffles, said plunger being a substantially rotationally symmetrical body, and a device and a method of production of said plunger. The invention further relates to a method and a device for the production of dental prostheses with muffles and plungers according to the invention.

### BACKGROUND OF THE INVENTION

Numerous muffles, which are of substantially cylindrical shape, are already known from the prior art for the production of dental prostheses.

As an example we may mention DE 20 2005 003 014 U1, which describes a muffle with two cylindrical regions, the muffle being roughly pear-shaped and having convex and concave regions.

DE 20 2007 004 265 U1 describes a muffle that is purely cylindrical. A muffle of a similar type is also described in DE 10 2004 013 668 A1.

Generally when using muffles from the prior art or other usual muffles, numerous problems or disadvantages arise. The main problem is the production of large bridges in one piece. Generally, individual sections of bridges are produced separately in different muffles and are then assembled. The existing muffles do not offer sufficient space for larger prosthetic structures. In particular, the receiving space for the charge in the muffle only has a size of up to 10 cm³ in the largest muffles currently known, which allows a maximum charge of ceramic weighing about 20 g. However, a larger charge is often required for overpressing extensive bridges.

A problem that arises with large dental prostheses is the development of thermal stress cracks, which arise on account of the high stresses caused by heating and cooling and are transmitted from the muffle to the ceramic of the dental prosthesis.

Furthermore, owing to the compact design of the commercially available ceramic pressing furnaces, these do not have sufficient space for the production of larger dental prostheses in large muffles that this requires.

Another problem is that muffles and plungers are made from different materials, as this leads to differences in expansion of the individual materials and therefore there is also increased formation of stress cracks in the ceramic.

To summarize the state of the art, it can be said that at present the use of pressing ceramics for applications in dentistry is restricted to the production of small parts. Known methods of production of dental prostheses are the overpress method (zircon overpressed with ceramic) and the press-on-metal method, but for both methods, only small dental prostheses (up to approx. 10 cm³ or up to approx. 20 g) can be produced. For the usual ceramic pressing furnaces, at present individual muffles are made by the manufacturers for their respective ceramic pressing furnaces. This means in practice that the commercially available muffles do not allow universal application.

### OBJECTS AND SUMMARY OF THE INVENTION

The aim of the invention is to solve the aforementioned problems by providing a muffle with a large receiving space (larger than 10 cm³) and a suitable plunger.

In the muffle according to the invention this is achieved in that the proportion of cylindrical surface regions about the muffle axis, relative to the total surface area of the outer contour of the muffle, is less than 30%, and preferably less than 20%. In various embodiments of the muffle, this proportion of cylindrical surface regions about the muffle axis relative to the outer contour of the muffle can be less than 25%, preferably less than 15% or less than 20%, preferably less than 10%. Especially advantageously, it is to be envisaged that the outer contour of the muffle is substantially convex.

Substantially convex design means in this context that at least one small region, preferably in the base region of the muffle, can also be concave, and this region serves for centering the muffle in the ceramic pressing furnace. Depending on the type of furnace, the concave region can also be adapted or omitted. Generally the convex design of the muffle offers the advantage that stress cracks are largely neutralized or prevented.

The outer contour of the muffle is the region that is not formed by the receiving space for the charge or the plunger and the female die of the dental prosthesis. In this connection, reference should be made to FIG. 14, which is described later.

In a special embodiment it is envisaged that the outer contour of the muffle has at least two truncated-cone-shaped regions, said truncated-cone-shaped regions having different cone angles (α,β). This embodiment means that the muffle has optimal utilization of the space in the ceramic pressing furnace, especially in the upper region, thereby improving the heat penetration properties of the muffle.

Preferably it should also be envisaged that the muffle has at least one cylindrical region. Especially in the widest region of the muffle, the cylindrical design is able to offer sufficient space for large dental prostheses.

Moreover, it should preferably be envisaged that the muffle has at least one curved surface region. This at least one curved region serves mainly for neutralizing stress cracks. As far as possible, all sharp edges that arise in the prior art for muffles should be avoided according to the invention by means of a curved surface form.

Despite the advantageous convex design of the muffle, it should be envisaged that the outer contour of the muffle is flattened in the top and bottom region. Although stress cracks are best prevented with a fully convex design of the muffle (e.g. ovoid or spherical), the flattened design of the muffle is important in the pressing process, because the compression forces can then be transmitted better and more uniformly from top to bottom. In particular the flattened bottom region serves for transmitting the compression forces over a large area, because with a rounded design of the bottom (base) the stability of the whole muffle is impaired during the pressing process.

Especially advantageously, for the flattened regions it should be envisaged that between 5 and 55%, preferably between 30 and 45%, of the outer contour is formed at right angles to the muffle axis.

In an especially advantageous embodiment, the rotationally symmetrical body of the muffle relative to the outer contour and viewed from top to bottom has a truncated-cone-shaped body with a cone angle (α), a truncated-cone-shaped body with a cone angle (β), with α>β, a cylindrical body and a rotationally symmetrical body with curved surface. In numerous tests and with various possibilities for design of the muffle, this shape of the muffle was found to be especially resistant to stress cracking. In particular, the cone angle is β 79° and the cone angle is α 62°. In addition to this advantageous embodiment, it can be envisaged that the muffle has a wider cylindrical body, which is preferably arranged in the lower region of the muffle. This region serves, as already mentioned, for fixing the position of the muffle in the ceramic pressing furnace during pressing.

An advantageous embodiment, which does not refer to the aforementioned possible embodiments, envisages that the proportion of cylindrical surface regions about the muffle axis relative to the outer contour of the muffle is 0%. This embodiment offers a particular advantage with respect to resistance to stress cracking.

For the production of a muffle according to the invention, protection is sought for a device in which a liquid embedding compound can be cured in a cavity to form a muffle. The cavity of this device forms the female die of the muffle according to the invention. In particular, the cavity of the device is formed by two shapers, a medium that can be burnt out without residue located on a pegging mandrel of a shaper and a silicone ring. Other shaping parts for forming a cavity for the production of a muffle should also not be ruled out in the sense of the invention.

In this connection, a method should also be protected in which a muffle can be cured in a device according to the aforementioned embodiments.

The plunger, which compresses the charge in the female die of the dental prosthesis in a muffle, forms a second independent aspect of the invention. Plungers for the production of dental prostheses in muffles, with the plunger being a substantially rotationally symmetrical body, are already known.

The aim of a plunger according to the invention is to press a charge—preferably large and weighing more than 20 g—into the female die of the dental prosthesis in the muffle.

With the plunger according to the invention, this aim is achieved in that the ratio of height to base diameter of the plunger is in the range from 2:1 to 1:4, preferably around 1:1.

Advantageously, it can moreover be envisaged that the diameter of the plunger is narrower in the upper region than in the lower region. This design is beneficial for the transmission of force from the sender via the plunger onto the embedding compound in a relatively wide receiving space (diameter greater than 10 mm, preferably approx. 27 mm).

At present, plungers are commercially available that have a diameter of approx. 10 mm and a height of approx. 30 to 40 mm, thus only press directly on a commercially available blank, and several blanks can be placed on top of one another. With the advantageous design of the plunger in the lower region of more than 10 mm, preferably 27 mm, not only is it possible to press on an individual blank, but also on several blanks arranged next to one another. In this way it is possible to compress nine blanks weighing approx. 3 g in the receiving space of the muffle by the plunger, so that a bridge structure with up to 14 sections can be produced in one operation. Preferably the plunger forms the same shape as the pegging mandrel and is curved in at least one surface region.

Especially advantageously, it can be envisaged that the diameter of the upper region corresponds substantially to the diameter of a sender of a ceramic pressing furnace and in the lower region substantially to the diameter of the receiving space.

Especially advantageously, it is further envisaged that the proportion of cylindrical surface regions about the plunger axis relative to the total surface area of the plunger is less than 80%, preferably less than 60%. It also has to be taken into account that the plunger is substantially convex. Moreover, it can be envisaged that the plunger has at least one truncated-cone-shaped region.

In particular, moreover, protection is sought for a device for the production of a plunger as mentioned above for use in a muffle as mentioned above, where a liquid embedding compound can harden in a cavity of the device to form a plunger.

Advantageously, it is to be envisaged that the cavity of the device forms the female die of the plunger.

In one embodiment the cavity of the device is formed by a silicone body and a shaper. Preferably the silicone body and the shaper come into contact in the transition region from the truncated-cone-shaped region of the plunger to the cylindrical region of the plunger.

Protection is also sought in this context for a method of production of a plunger, in which the plunger can be cured in a device as mentioned above for the production of plungers.

Protection is also sought for a method of production of dental prostheses, in which a muffle and a plunger are heated in a preheating furnace, a charge for the dental prosthesis is put in a receiving space of the muffle, the receiving space plus charge is covered with the plunger, the muffle, the charge and the plunger are put in a ceramic pressing furnace, in which a vacuum is produced, and the charge is pressed by a plunger into a female die formed by the medium in the muffle at approx. 930° C.

It is particularly important according to the invention that the muffle and the plunger consist of the same embedding compound. The embedding compound is prepared by dental technicians during production of the muffle, and generally some residue is left over. This residue can according to the invention be cured in a device to form a plunger, which therefore has exactly the same material composition as the muffle. As the plunger and the muffle are heated simultaneously for the pressing of the dental prosthesis in the ceramic pressing furnace, the use of one and the same embedding compound for the production of both components is also of considerable advantage for the prevention of stress cracks.

Another aspect of the invention relates to a device for the production of dental prostheses with a muffle and a plunger, where a female die of the dental prostheses and a receiving space for a charge that is to be pressed, in particular for an embedding compound, are formed in the muffle. It is then envisaged that the receiving space has a volume of more than 11 cm³, preferably of more than 12.5 cm³.

Advantageously, it can be envisaged in this method that the receiving space has a volume between 15 and 30 cm³, preferably between 17 and 23 cm³. In the known Pressmaster, the receiving space has a volume of approx. 10 cm³. In contrast, the muffle according to the invention offers, especially when using the press-on-metal technique for the production of extensive bridges, a larger receiving space and therefore a higher charge capacity. The charge capacity of nine blanks corresponds to a volume of 10.86 cm³. The weight of 9 blanks is 26.6 g for PoM blanks, 28.5 g for E-mex-press blanks and 25.6 g for E-mex-cirpress blanks. The density differences arise owing to different composition of the blanks, for instance the E-mex-press blank consists of lithium disilicate.

In a further advantageous refinement it is provided that the proportion of cylindrical surface regions about the muffle axis relative to the outer contour of the muffle is less than 25%, preferably less than 15%.

In a further advantageous refinement it is provided that the proportion of cylindrical surface regions about the muffle axis relative to the outer contour of the muffle is less than 20%, preferably less than 10%.

In a further advantageous refinement it is provided that the outer contour of the muffle is substantially convex.

In a further advantageous refinement it is provided that the outer contour of the muffle has at least two truncated-cone-shaped regions.

In a further advantageous refinement it is provided that the truncated-cone-shaped regions have different cone angles.

In a further advantageous refinement it is provided that the muffle has at least one cylindrical region.

In a further advantageous refinement it is provided that the muffle has at least one curved surface region.

In a further advantageous refinement it is provided that the outer contour of the muffle is flattened in the upper region and lower region.

In a further advantageous refinement it is provided that between 5 and 55%, preferably between 30 and 45%, of the outer contour is formed at a right angle to the muffle axis.

In a further advantageous refinement it is provided that the rotationally symmetrical body of the muffle relative to the outer contour and viewed from top to bottom has a truncated-cone-shaped-body with a cone angle α, a truncated-cone-shaped body with a cone angle β where α>β, a cylindrical body and a rotationally symmetrical body with curved surface.

In a further advantageous refinement it is provided that the muffle has a wider cylindrical body, preferably arranged in the lower region of the muffle and constructed as a base.

In a further advantageous refinement it is provided that the proportion of cylindrical surface regions about the muffle axis relative to the outer contour of the muffle is 0%.

In a further advantageous refinement it is provided that a liquid embedding compound can harden in a cavity to form a muffle.

In a further advantageous refinement it is provided that the cavity of the device forms the female die of the muffle.

In a further advantageous refinement it is provided that the cavity of the device is formed by two shapers, a medium that burns away without residue that is located on a pegging mandrel of a shaper and a silicone ring.

In a further advantageous refinement it is provided that the muffle can harden in a device.

In a further advantageous refinement it is provided that the ratio of height to base diameter of the plunger is in the range from 2:1 to 1:4, preferably about 1:1.

In a further advantageous refinement it is provided that the diameter of the plunger is smaller in the upper region than in the lower region.

In a further advantageous refinement it is provided that the diameter of the upper region corresponds substantially to the diameter of a sender of a ceramic pressing furnace and in the lower region corresponds substantially to the diameter of the receiving space.

In further advantageous refinement it is provided that the proportion of cylindrical surface regions about the plunger axis—relative to the total surface area of the plunger—is less than 80%, preferably less than 60%.

In further advantageous refinement it is provided that the plunger is substantially convex.

In further advantageous refinement it is provided that the plunger has at least one truncated-cone-shaped surface region.

In further advantageous refinement it is provided that the plunger has a curved surface region.

In further advantageous refinement it is provided that the rotationally symmetrical body of the plunger—viewed from top to bottom—has a truncated-cone-shaped body, a cylindrical body and a rotationally symmetrical body with curved surface.

In further advantageous refinement it is provided that a liquid embedding compound can harden in a cavity of the device to form a plunger.

In further advantageous refinement it is provided that the cavity of the device forms the female die of the plunger.

In further advantageous refinement it is provided that the cavity of the device is formed by a silicone body and a shaper.

In further advantageous refinement it is provided that the plunger can harden in a device.

In further advantageous refinement it is provided that a muffle and a plunger are heated in a preheating furnace, a charge for the dental prosthesis is placed in a receiving space of the muffle, the receiving space plus charge is covered with the plunger, the muffle, the charge and the plunger are put in a ceramic pressing furnace, which produces a vacuum, the charge is pressed by the plunger into a female die formed by the medium in the muffle.

In further advantageous refinement it is provided that the muffle and the plunger consist of the same embedding compound.

In further advantageous refinement it is provided that a device for the production of dental prostheses with a muffle and a plunger with a female die of the dental prostheses and a receiving space for a charge that is to be pressed, in particular for a dental prosthesis compound, being formed in the muffle, characterized in that the receiving space has a volume of more than 11 cm³, preferably more than 12.5 cm³. In further advantageous refinement it is provided that the receiving space has a volume between 15 and 30 cm³, preferably between 17 and 23 cm³.

### BRIEF DESCRIPTION OF THE FIGURES

Further details and advantages of the present invention are explained in the following description of the figures, referring to the examples of application shown in the drawings, showing:

FIG. 1 shows a cross-section of the muffle according to the invention with plunger and charge before pressing,

FIG. 2 shows a cross-section of the muffle with plunger during pressing,

FIGS. 3, 4, 5 and 6 show the steps in the production of the muffle,

FIGS. 7 and 8 show the production of the plunger,

FIG. 9 shows a cross section of the device for the production of a plunger,

FIG. 10 shows the plunger,

FIG. 11 shows the plunger and the muffle together with the charge before pressing,

FIG. 12 shows the ceramic pressing furnace, the muffle and the plunger before pressing,

FIG. 13 shows the pressed-in dental prosthesis,

FIG. 14 shows a cross section identifying the outer and inner contour,

FIG. 15 shows a vertical top view of the receiving space plus charge,

FIG. 16 shows a view of the receiving space plus charge and

FIG. 17a to 17e show cross sections of plungers.

### DETAILED DESCRIPTION

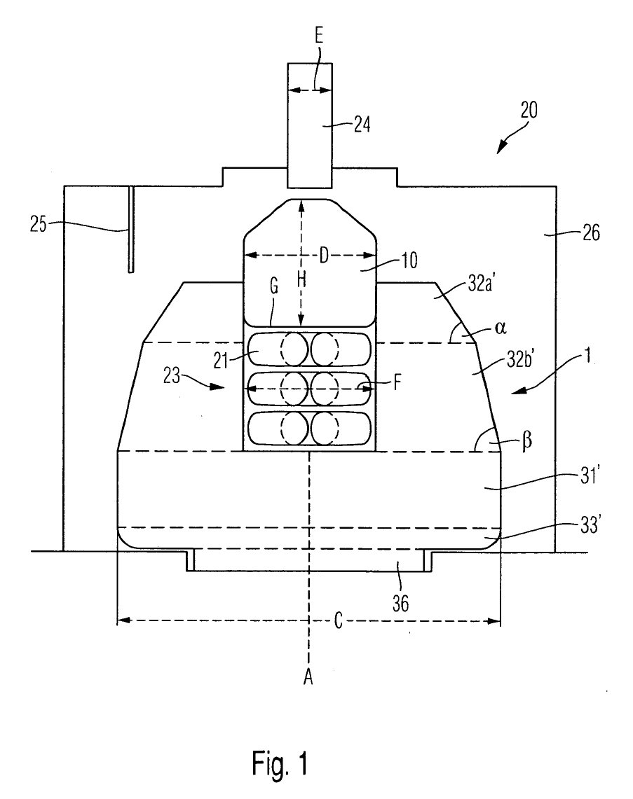

FIG. 1 shows a cross section of the concrete embodiment of a muffle according to the invention. In this case the furnace chamber 26, of the ceramic pressing furnace has a diameter of 9.8 cm (the furnace EP5000 from the company Ivoclar serves for example as the ceramic pressing furnace). Viewing from top to bottom, in the uppermost region the muffle has a truncated-cone-shaped body 32a′ with a cone angle of 62°. This is followed by a truncated-cone-shaped body 32b′ with a cone angle of 79°. In this case, these two together have a height of 4 cm. Next there is a cylindrical body 31′ and then a curved, rotationally symmetrical body 33′, which together have a height of 2.7 cm. For fitting the muffle in this kind of ceramic pressing furnace, a base 36 is also provided at the bottom, and this holds the complete muffle in place during the pressing process. The diameter of the complete muffle 1 is 8 cm in the cylindrical region 31. The periphery of the receiving space 23 forms the inner contour 18 of muffle 1 (see FIG. 14), and in this case the receiving space 23 has the same height as the two upper truncated-cone-shaped regions 32a and 32b and is therefore 4 cm high (though this provision is not obligatory). The charge 21, consisting of nine blanks, is shown in this receiving space 23, and represents maximum filling. The diameter D of the plunger 10 is equal to the diameter F of the receiving space 23, so that the plunger fits exactly in the receiving space 23. The plunger has a height of 3 cm, and in the uppermost region of the plunger 10 the sender 24 of the ceramic pressing furnace 20 with a diameter E of 1 cm impinges on the plunger 10. A thermostat 25 for controlling the internal temperature is shown on the left. The female die of the dental prostheses 2 is not shown.

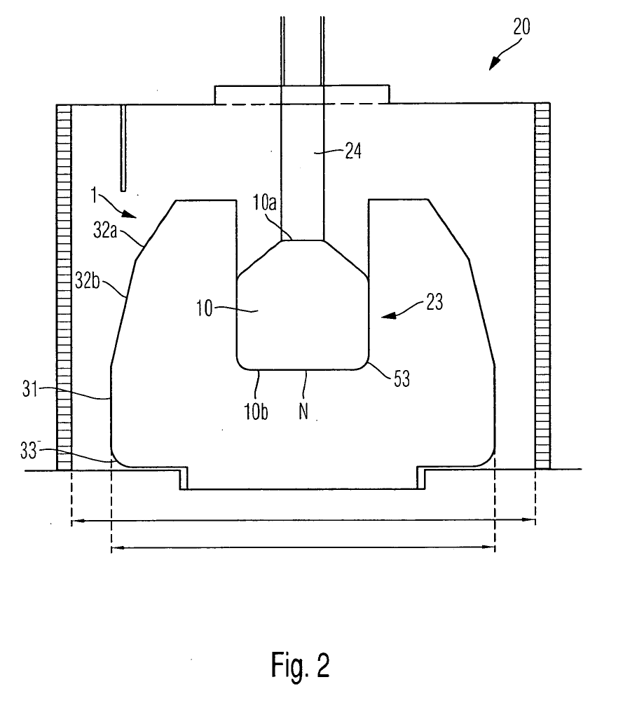

FIG. 2 shows the same muffle 1 as FIG. 1, this time after carrying out the pressing process. Sender 24 of the ceramic pressing furnace 20 has been withdrawn, so that the plunger 10 stops at the null point N of the receiving space 23. In this way the full charge 21 is pressed into the cavity of the dental prostheses (not shown). The lower rounded region 53 of the plunger 10 is made to be an exact fit with the rounded area of the receiving space 23. In this case the truncated-cone-shaped surface regions 32a and 32b, the cylindrical surface region 31 and the curved surface region 33 are indicated. The chamfer or curvature in the lower region 10b of plunger 10 opposes possible jamming of plunger 10 in the receiving space 23 and serves to reduce stress and for easier “threading” of the plunger 10 into the receiving space 23.

FIG. 3 shows the shaper 6 with the funnel opening, the silicone ring 9 and the shaper 7 with pegging mandrel 7a, which form a part of the cavity 5a for receiving the liquid embedding compound 4 for the production of the muffle 1.

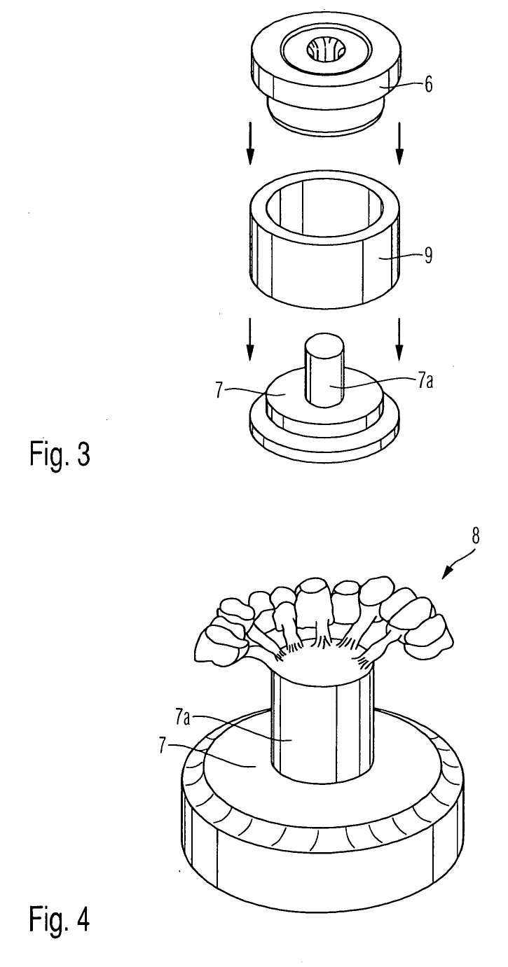

FIG. 4 shows an even more detailed illustration of the shaper 7 with the pegging mandrel, and the medium 8 that burns away without residue, and forms the male die of the dental prosthesis 2, is arranged on the pegging mandrel 7a.

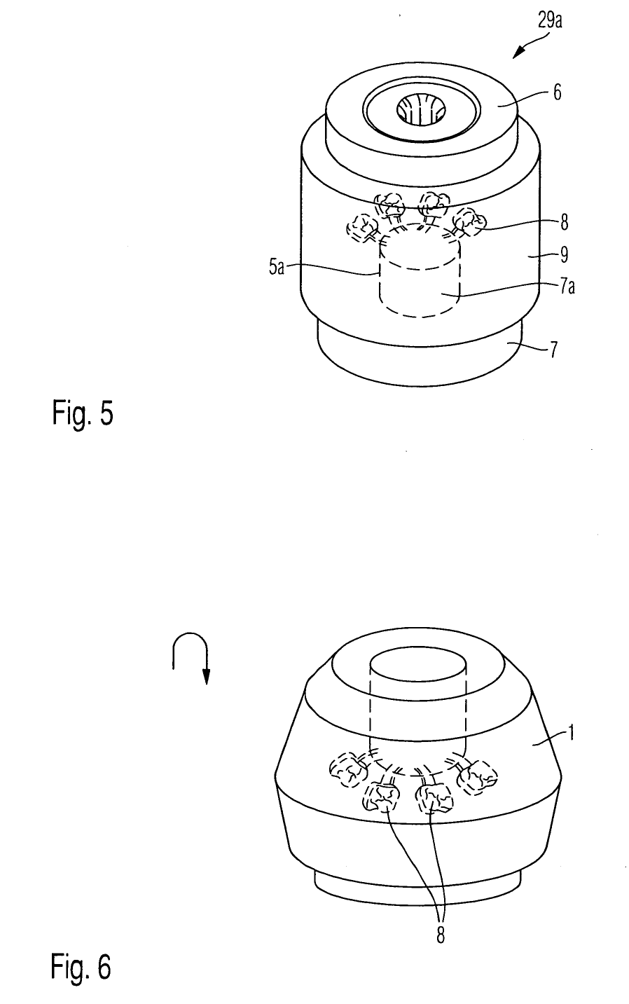

These four components for forming the cavity 5a for the production of the muffle 1 can now be seen in assembled form in FIG. 5. This cavity 5a is filled with the liquid embedding compound 4. The embedding compound 4 hardens in approx. 10 to 25 minutes, after which the shaper 6, the silicone part 9 and the shaper 7 can be removed, moreover, owing to the rotationally symmetrical design, the shaper 7 with the pegging mandrel 7a not only can be pulled out, but preferably can be twisted out, without any fear of stress cracks developing.

Following the removal of these three components just mentioned, as shown in FIG. 6, an “upside-down” muffle 1 remains, and in the region for the dental prostheses 2, the medium 8 that burns away without residue still fills the cavity in the muffle 1. On heating and hardening the muffle 1 in the preheating furnace 19 (not shown here) the medium 8 (which is preferably organic or high-purity wax) burns away without residue.

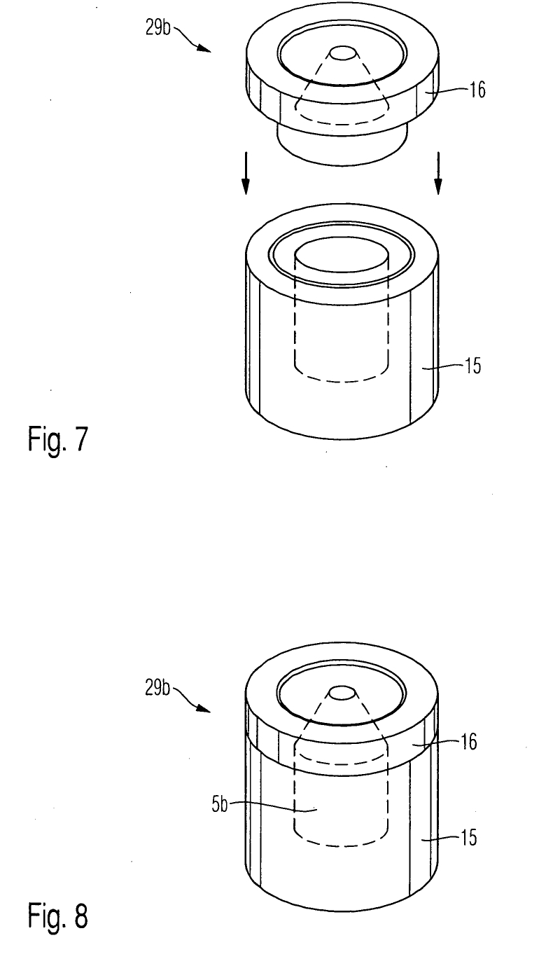

FIG. 7 now shows the device 29b for the production of the plunger 10, said device consisting of the shaper 16 and the silicone body 15. FIG. 8 shows how these two components form the cavity 5b for the plunger 10.

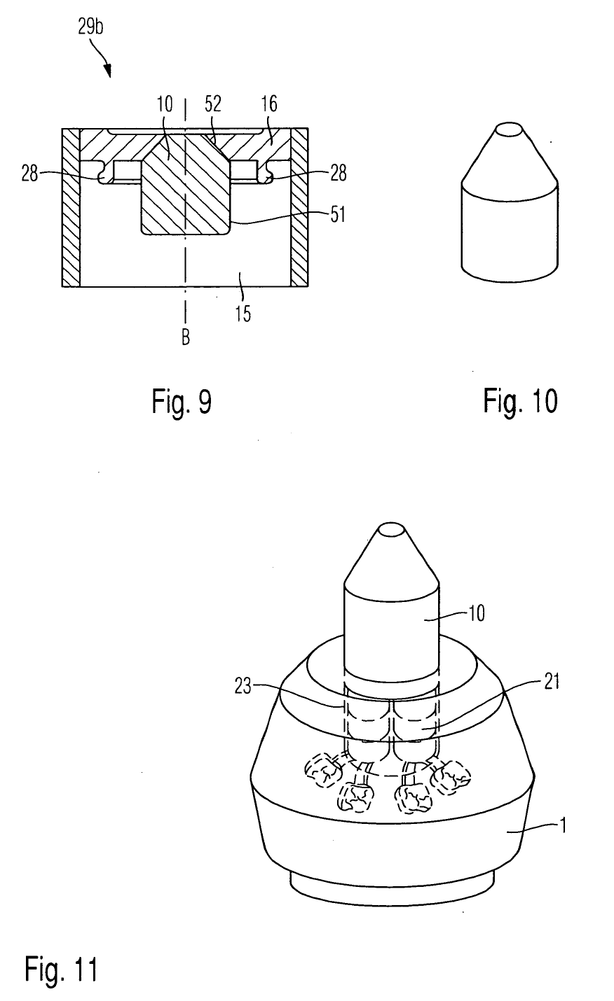

FIG. 9 shows a cross section of this device 29b through the plunger axis B. It also shows the special design and the interlocking of shaper 16 and in the silicone body 15 by the shaper plates 28. The contact region of silicone body 15 and shaper 16 precisely forms the transition from the truncated-cone-shaped region 52 of plunger 10 into the cylindrical region 51 of plunger 10, which guarantees an absolutely level surface of plunger 10. The diameter of the complete device 29b is 6.8 cm and the height is 5.5 cm. The plunger 10 has a diameter D of 2.7 cm.

FIG. 10 shows a perspective view of the liquid embedding compound 4 hardened in the cavity 5b of device 29b for the production of the plunger 10.

FIG. 11: In the production process for a dental prosthesis 2, the plunger 10 and the muffle 1, which are obtained from one and the same liquid embedding compound 4, are heated together in the preheating furnace 19 (not shown) to approx. 850° C. After heating these two components for about 90 minutes, they are removed from the preheating furnace 19, loaded with the desired charge 21 in the receiving space 23 of muffle 1, and then immediately put in the ceramic pressing furnace 20 (see FIG. 12), in which the pressing process is carried out. This pressing process proceeds largely automatically and takes between 10 and 40 minutes; the charge 21 becomes viscous in ceramic pressing furnace 20 heated to approx. 910° to 950° C. and is pressed, via the sender 24 and the plunger 10 into the female die of the dental prostheses 2, under vacuum in the ceramic pressing furnace 20.

FIG. 12 shows the ceramic pressing furnace 20 in the opened state before pressing, with the muffle 1 and the plunger 10 inside.

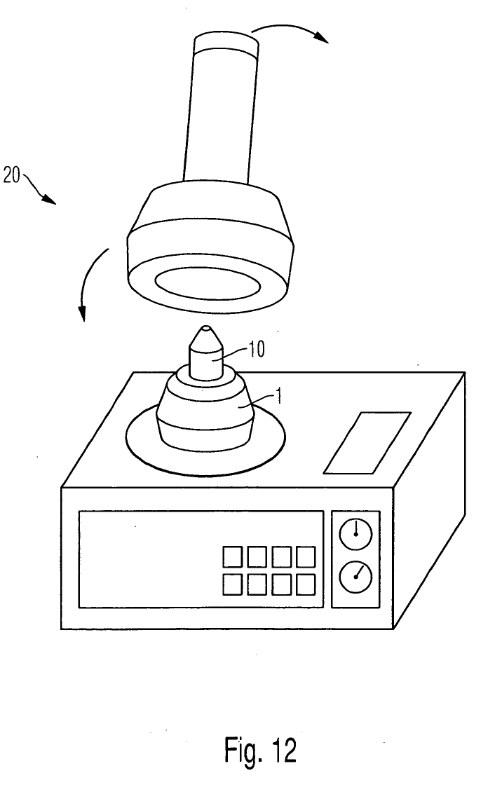

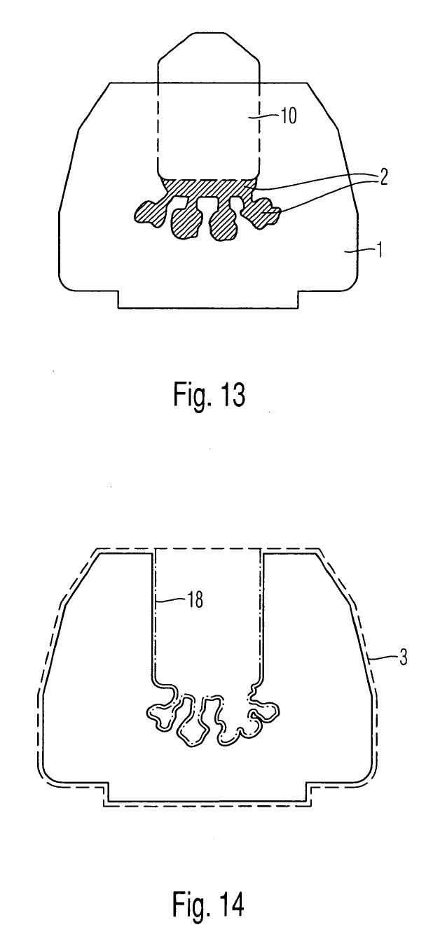

FIG. 13 shows a cross section of the muffle 1 and plunger 10 with the dental prosthesis 2 consisting of hardened ceramic.

For better understanding, FIG. 14 shows the outer contour 3 of the muffle 1 with a dashed line. The outer contour 3 forms, as it were, the outer periphery of the muffle 1, whereas the inner contour 18 forms the inward-facing surface region of the muffle. The inner contour 18 is formed by the pegging mandrel 7a of the shaper 7 and the medium 8.

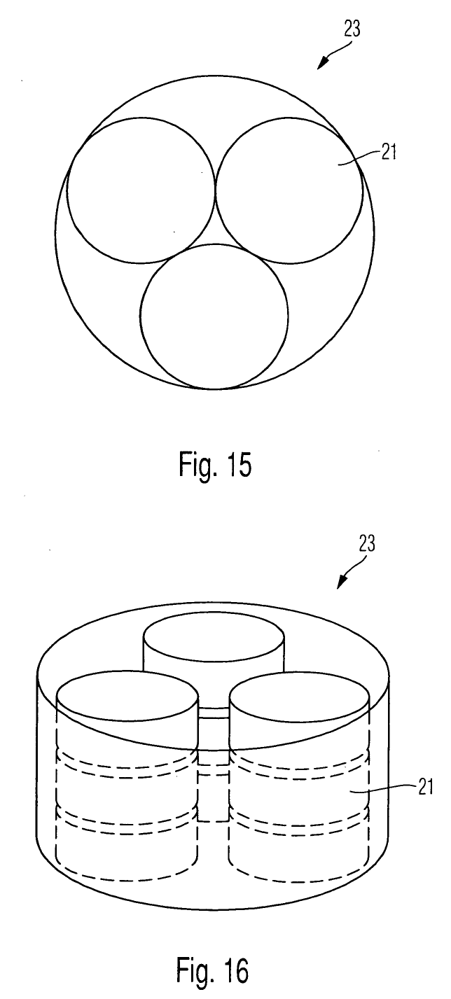

FIG. 15 shows the receiving space 23 plus charge 21, viewed from above. It shows the currently used blanks with a diameter of approx. 1 cm. Other types and sizes of embedding compounds or blanks are also possible for use in a muffle 1 according to the invention, for example a blank that corresponds to the shape of the receiving space 23 according to the invention and fills it exactly, would provide approx. 67% better utilization of the filling volume. This means that the receiving space 23, with a diameter of 2.7 cm and a height of 3 cm, has a volume of 17.18 cm³, whereas 9 of the existing blanks (see FIG. 16) with a diameter of approx. 1.2 cm and a height of 1 cm have a volume of approx. 10.18 cm³. Even with possible future use of some kind of granules instead of blanks, the receiving space 23 according to the invention offers sufficient volume for producing up to 14-membered bridge structures in one piece. Especially for structures that do not have a metal structure, considerably more ceramic compound is required, which is supported by the design of muffle and plunger according to the invention. In the production of the dental prostheses 2 in certain ceramic pressing furnaces 20, the receiving space 23 can have a height of up to 4 cm and therefore offer a filling volume of up to 22.9 cm³. With this it would be possible to press even more than 9 of the existing blanks.

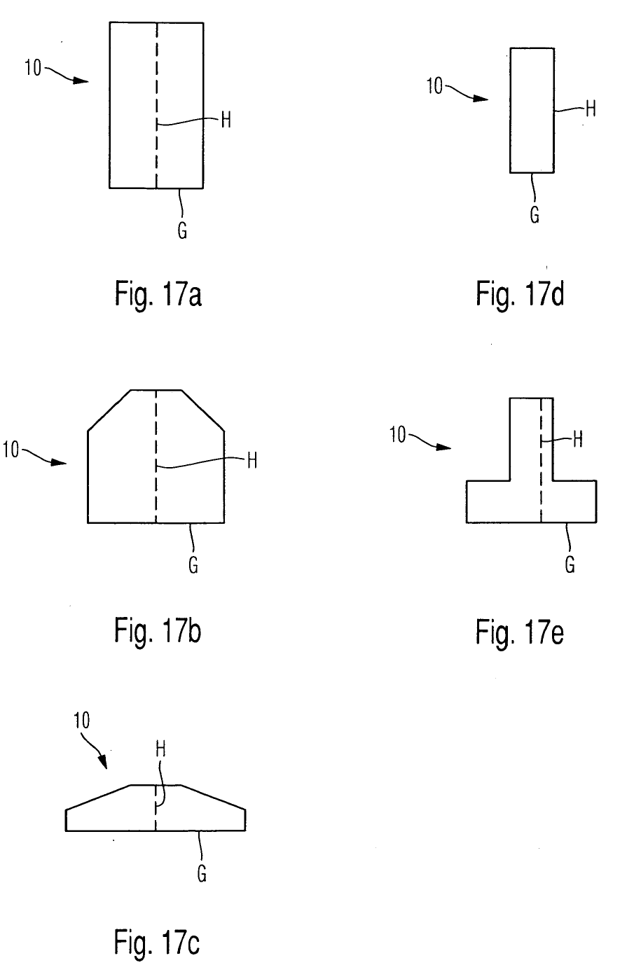

FIGS. 17a to 17c show cross sections of plungers 10 that are possible according to the invention, with a ratio of height to base diameter (H:B) of 2:1 for FIG. 17a, 1:1 for FIG. 17b and 1:4 for FIG. 17c. A factor that these different embodiments have in common is that the plunger 10 has a larger pressing area (base area) than in FIG. 17d, which shows the prior art with a ratio of height to base diameter of 3:1 and a diameter D of approx. 10 mm.

FIG. 17e shows another possible design of a plunger 10 with H:B ratio of approx. 1:1. It should be mentioned that a plunger 10 with such a cross section already exists, but it is not of rotationally symmetrical design, so that, especially when removing the plunger 10 from the muffle 1 after pressing, problems arise (possibly stress cracks, breaking, jamming etc.). As the plunger 10 is rounded or curved in the lowest region 53, the region above the rounded region 53 is taken as the base diameter B. In other words the widest region of the plunger 10 can be taken as the base diameter B. A very flat design of the plunger 10 (H:B approx. 1:5 to 1:100) is also possible for carrying out the pressing process, but a different material would have to be used for the plunger 10, which once again is not beneficial for the stresses during pressing. It can also not be ruled out that the sender 24 of the ceramic pressing furnace 20 presses directly on the charge 21, so that in the device according to the invention according to Claim 32 the plunger 10 would be superfluous.

In order to disclose all aspects of the invention in this specification, further important points of the invention are presented below.

In general, use of the device according to the invention together with muffle and plunger also for the production of dental prostheses for animals that have a larger bite than humans should also not be ruled out.

For the embedding compound it is possible for example to use silicon dioxide, magnesium oxide, ammonium phosphate etc. The two shapers or the respective shapers can consist of a plastic (for example polyoxymethylene). The silicone ring can consist of silicone and the medium that burns away without residue can consist of wax. The lost-wax technique is used for burning away the medium.

In general, the muffle according to the invention (which in the concrete example of application according to the invention has a weight between 300 g and 600 g) is suitable for all known conventional furnaces with hydraulic opening mechanism or with hinged mechanism, especially on account of the special design.

This type of muffle is also suitable in the new generation of furnaces with considerably smaller burning chamber for better management of burning. The special ovoid-shaped design prevents or minimizes the occurrence of stress cracks. The formation of stress cracks is also minimized by using the same materials for muffle and plunger.

The muffle according to the invention is particularly advantageous for the pressing of circular (horseshoe-shaped) bridges. In contrast to the Pressmaster; no disposable push-on cap is required. Owing to the special design with the two truncated-cone-shaped regions, the muffle withstands a far higher contact pressure than comparable muffles. The labor costs are also much lower, as the muffle and the plunger can be produced in one piece and display the same expansion. Especially in view of the many pressing channels, which are indispensable for the production of a circularly overpressed metal structure, the muffle according to the invention is especially suitable for plunger systems. Especially in the overpress method, an extremely good edge closure fit (ceramic stages) is achieved.

From the standpoint of dentistry, the solution according to the invention is of considerable interest both for dental technicians and for dentists, because in this way it is possible for the first time to treat complex cases with large-span bridge structures using the overpress technique.

While a preferred form of this invention has been described above and shown in the accompanying drawings, it should be understood that applicant does not intend to be limited to the particular details described above and illustrated in the accompanying drawings, but intends to be limited only to the scope of the invention as defined by the following claim. In this regard, the term “means for” as used in the claim is intended to include not only the designs illustrated in the drawings of this application and the equivalent designs discussed in the text, but it is also intended to cover other equivalents now known to those skilled in the art, or those equivalents which may become known to those skilled in the art in the future.

What is claimed is:

1. Muffle for the production of dental prostheses, said muffle being a body that is substantially rotationally symmetrical about the muffle axis, characterized in that the proportion of cylindrical surface regions (31) about the muffle axis (A)—relative to the total surface area of the outer contour (3) of the muffle (1)—is less than 30%, preferably less than 20%.

2. Muffle according to claim 1, characterized in that the proportion of cylindrical surface regions (31) about the muffle axis (A) relative to the outer contour (3) of the muffle (1) is less than 25%, preferably less than 15%.

3. Muffle according to claim 1, characterized in that the proportion of cylindrical surface regions (31) about the muffle axis (A) relative to the outer contour (3) of the muffle (1) is less than 20%, preferably less than 10%.

4. Muffle according to claim 1, characterized in that the outer contour (3) of the muffle (1) is substantially convex.

5. Muffle according to claim 1, characterized in that the outer contour (3) of the muffle (1) has at least two truncated-cone-shaped regions (32a, 32b).

6. Muffle according to claim 3, characterized in that the truncated-cone-shaped regions (32a, 32b) have different cone angles (,).

7. Muffle according to claim 1, characterized in that the muffle (1) has at least one cylindrical region (31).

8. Muffle according to claim 1, characterized in that the muffle (1) has at least one curved surface region (33).

9. Muffle according to claim 1, characterized in that the outer contour (3) of the muffle (1) is flattened in the upper region (34) and lower region (35).

10. Muffle according to claim 9, characterized in that between 5 and 55%, preferably between 30 and 45%, of the outer contour (3) is formed at a right angle to the muffle axis (A).

11. Muffle according to claim 1, characterized in that the rotationally symmetrical body of the muffle (1) relative to the outer contour (3) and viewed from top to bottom has a truncated-cone-shaped body (32a′) with a cone angle (α), a truncated-cone-shaped body (32b′) with a cone angle (β), where α>β, a cylindrical body (31′) and a rotationally symmetrical body with curved surface (33′).

12. Muffle according to claim 11, characterized in that the muffle (1) has a wider cylindrical body (31′), preferably arranged in the lower region (35) of the muffle (1) and constructed as a base (36).

13. Muffle according to claim 1, characterized in that the proportion of cylindrical surface regions (31) about the muffle axis (A) relative to the outer contour (3) of the muffle is 0%.

14. Device for the production of a muffle being a body that is substantially rotationally symmetrical about the muffle axis, characterized in that a liquid embedding compound (4) can harden in a cavity (5a) to form a muffle (1).

15. Device according to claim 14, characterized in that the cavity (5a) of the device (29a) forms the female die of the muffle (1).

16. Device according to claim 14, characterized in that the cavity (5a) of the device (29a) is formed by two shapers (6, 7), a medium that burns away without residue (8) that is located on a pegging mandrel of a shaper (7) and a silicone ring (9).

17. Method of production of a muffle being a body that is substantially rotationally symmetrical about the muffle axis, characterized in that the muffle (1) can harden in a device (29a).

18. Plunger for the production of dental prostheses in muffles, said plunger being a substantially rotationally symmetrical body, characterized in that the ratio of height to base diameter (H:B) of the plunger (10) is in the range from 2:1 to 1:4, preferably about 1:1.

19. Plunger according to claim 18, characterized in that the diameter (D) of the plunger (10) is smaller in the upper region (10a) than in the lower region (10b).

20. Plunger according to claim 18, characterized in that the diameter (D) of the upper region (10a) corresponds substantially to the diameter (E) of a sender (24) of a ceramic pressing furnace (20) and in the lower region (10b) corresponds substantially to the diameter (F) of the receiving space (23).

21. Plunger according to claim 18, characterized in that the proportion of cylindrical surface regions (51) about the plunger axis (B)—relative to the total surface area (50) of the plunger (10)—is less than 80%, preferably less than 60%.

22. Plunger according to claim 18, characterized in that the plunger (10) is substantially convex.

23. Plunger according to claim 18, characterized in that the plunger (21) has at least one truncated-cone-shaped surface region (52).

24. Plunger according to claim 18, characterized in that the plunger (19) has a curved surface region (53).

25. Plunger according to claim 18, characterized in that the rotationally symmetrical body of the plunger (10)—viewed from top to bottom—has a truncated-cone-shaped body (52′), a cylindrical body (51′) and a rotationally symmetrical body with curved surface (53′).

26. Device for the production of a plunger being a substantially rotationally symmetrical body for the pressing of dental prostheses in a muffle, in particular in a muffle being a body that is substantially rotationally symmetrical about the muffle axis, characterized in that a liquid embedding compound (4) can harden in a cavity (5b) of a device (29b) to form a plunger (10).

27. Device according to claim 26, characterized in that the cavity (5b) of the device (29b) forms the female die of the plunger (10).

28. Device according to claim 26, characterized in that the cavity (5b) of the device (29b) is formed by a silicone body (15) and a shaper (16).

29. Method of production of a plunger being a substantially rotationally symmetrical body, characterized in that the plunger (10) can harden in a device (29b).

30. Method of production of dental prostheses, characterized in that a muffle (1) being a body that is substantially rotationally symmetrical about the muffle axis and a plunger (10) being a substantially rotationally symmetrical body are heated in a preheating furnace (19), a charge (21) for the dental prosthesis (2) is placed in a receiving space (23) of the muffle (1), the receiving space (23) plus charge (21) is covered with the plunger (10), the muffle (1), the charge (21) and the plunger (10) are put in a ceramic pressing furnace (20), which produces a vacuum, the charge (21) is pressed by the plunger (10) into a female die formed by the medium (8) in the muffle (1).

31. Method according to claim 30, characterized in that the muffle (1) and the plunger (10) consist of the same embedding compound (4).

32. Device for the production of dental prostheses with a muffle being a body that is substantially rotationally symmetrical about the muffle axis, and a plunger being a substantially rotationally symmetrical body, with a female die of the dental prostheses; and a receiving space for a charge that is to be pressed, in particular for a dental prosthesis compound, being formed in the muffle, characterized in that the receiving space has a volume of more than 11 cm³, preferably more than 12.5 cm³.

33. Device according to claim 32, characterized in that the receiving space has a volume between 15 and 30 cm³, preferably between 17 and 23 cm³.
